(19) United States
(12) Patent Application Publication
(10) Pub. No.: US 2005/0186913 A1
(43) Pub. Date: Aug. 25, 2005

(54) Remote user interface

(75) Inventor: Marcelo Varanda, Ottawa (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Research In Motion Limited, Waterloo (CA)

(21) Appl. No.: 10/785,888

(22) Filed: Feb. 24, 2004

(51) Int. Cl. H04M 1/00

(52) U.S. Cl. 455/67.11; 455/423

(57) ABSTRACT

A remote user interface for a wireless data device comprising: a client machine; a server machine; a communications channel for providing data exchange between the client machine and the server machine; and an interface for providing data exchange between the server machine and the wireless data device, wherein the client machine can send an input to the wireless data device using the communications channel and the interface, and the wireless device can provide information about a display on the wireless device to the client machine along the interface and the communications channel.

### FIELD OF THE INVENTION

This method and apparatus herein relates to a remote user interface and, in particular, to a remote user interface for a wireless data device.

### BACKGROUND OF THE INVENTION

When developing a wireless data device, one of the debugging steps includes testing the wireless data device in an actual network. This involves bringing the device to the location of the wireless network and performing a series of tests on the device.

Wireless networks vary depending on the service provider and the region the network is situated in. In order to test a wireless data device, it is therefore necessary to bring the wireless data device to these various locations, which can be an onerous task. A better solution would be to locate the wireless device at the remote location and to have the ability to perform the tests from a central location.

Further, once a device has been released to the public, technical support to the customers is occasionally required. This generally involves bringing the data device to the technical support or performing technical support over the telephone with the end user providing input into the wireless data device and then reporting the results back to technical support. In this case, it would again be more desirable for technical support to be able to directly control the wireless data device and to receive feedback from the data device.

Other reasons for remotely controlling a wireless data device and seeing the display of the device include training purposes where the device can be connected to an overhead projector and thereby project the display of the wireless device.

### SUMMARY OF THE INVENTION

The apparatus and method herein provide a remote user interface for a wireless data device. An interface such as a USB, iRDA or Bluetooth is established between the wireless data device and a remote personal computer, referred to herein as a server machine. The wireless data device includes software to capture the LCD display and this information is forwarded to the server machine computer.

The server machine has a network connection, which allows the server machine to be connected with a local personal computer referred to herein as a client machine. The server machine converts the data received over the interface from the wireless data device and sends it over the network to the client machine. At the client machine, software converts this data and displays it on the monitor of the client machine.

Keyboard or stylus input from the client machine is converted by software on the client machine and sent over the network to the server machine and over the interface to the wireless data device. An interface driver handling the interface for the wireless data device recognizes that it has received a data packet and simulates a driver for the wireless device, thereby causing the device to register the keystroke or stylus input performed at the client machine.

Alternatively, the client machine can include a graphic of the wireless data device on the monitor and data can be input using a mouse click over a key on the graphic of the remote data device.

In this way, a local user can control the remote wireless data device and obtain the results displayed on the wireless data device.

The invention therefore provides a remote user interface for a wireless data device comprising: a client machine; a server machine; a communications channel for providing data exchange between said client machine and said server machine; and an interface for providing data exchange between said server machine and said wireless data device, wherein said client machine can send an input to said wireless data device using said communications channel and said interface, and said wireless device can provide information about a display on said wireless device to said client machine along said interface and said communications channel.

The invention further provides a method of updating a screen of a client machine to display a user interface of a wireless data device connected to a server machine, said method comprising the steps of: generating a screen update request at said client machine; transmitting said screen update request over a communication link between said client machine and said server machine; converting screen update request to a data format appropriate for said wireless device; transferring said converted request over an interface to said wireless data device; interpreting said request at the said wireless data device; capturing a screen of said wireless data device to create captured screen data; transmitting said captured screen data to said server machine over said interface; converting said captured screen data to a format appropriate for said client machine; transmitting said converted captured screen data to said client machine; and updating the screen on said client machine.

The invention further provides method of remotely generating an input on a client machine for a wireless data device comprising the steps of: receiving an input on said client machine; sending said input to a server machine; converting said input for an interface to said wireless data device; sending said input over said interface; receiving said input at a wireless data device; interpreting said input on said wireless data device; simulating a driver for an input on said wireless data device; and inputting said input on said wireless data device.

The invention further provides a method of updating a screen of a client machine to display unit user interface of a wireless data device connected to a server machine, said method comprising the steps of: generating a request at said client machine to inform said client machine if said display on said wireless device changes; transmitting said request over a communication link between said client machine and said server machine; converting said request to a data format appropriate for said wireless device; transferring said converted request over an interface to said wireless data device; interpreting said request at the said wireless data device; waiting for said display at said wireless device to change; transmitting a message to said server machine over said interface when said display changes; converting said message to a format appropriate for said client machine; transmitting said converted message to said client machine; and generating a screen update request at said client machine.

The invention still further provides a method of updating a screen of a client machine to display unit user interface of a wireless data device connected to a server machine, said method comprising the steps of: generating a request at said client machine to inform said client machine if said display on said wireless device changes; transmitting said request over a communication link between said client machine and said server machine; converting said request to a data format appropriate for said wireless device; transferring said converted request over an interface to said wireless data device; interpreting said request at the said wireless data device; waiting for said display at said wireless device to change; capturing a screen of said wireless data device to create captured screen data one said display has changed; transmitting said captured screen data to said server machine over said interface; converting said captured screen data to a format appropriate for said client machine; transmitting said converted captured screen data to said client machine; and updating the screen on said client machine.

The inventions still further provides a method of inputting and receiving audio signals from a remote location on a wireless device, said method comprising the steps of: connecting an audio box to a telephone; connecting said audio box to a headset and speaker output of said wireless device, said audio box being capable of relaying said headset and speaker output to said telephone; connecting said audio box to a microphone input of said wireless device, said audio box being capable of relaying input from said telephone to said microphone input; connecting said audio box to a parallel port of a client machine, said client machine being capable of ending commands to said audio box to answer said telephone; sending a command to said client machine from a remote machine at said remote location to answer said telephone; telephoning said telephone from said remote location; and using said telephone to input and receive audio signals from said wireless device.

### BRIEF DESCRIPTION OF THE DRAWINGS

The above is best understood with reference to the drawings, in which:

FIG. 1 is a schematic diagram of the system herein;

FIG. 2 is a process flow chart for the steps required to update a client's screen;

FIG. 3 is a process flow chart for the steps required to simulate a stylus event on the wireless device;

FIG. 4 is a process flow chart of the steps required to simulate a keystroke on the wireless device;

FIG. 5 is a process flow chart of the steps required to simulate a stylus on the wireless device; and

FIG. 6 is an alternative embodiment, including an audio output and input for the wireless device.

### DETAILED DESCRIPTION OF THE PREFERRED EMBODIMENTS

Reference is now made to the drawings. The remote user interface 10 for a wireless device includes a client machine 12 that generally is located remotely from the wireless device. In a preferred embodiment, client machine 12 is a personal computer. Software running on client machine 12 displays an image simulating the wireless device. The display can be either only the LCD display as seen on the wireless device, or can include an image of the entire wireless device, including the LCD display and any keypad on the device.

Software running on client machine 12 further has the capability of interacting with a communications channel such as network 14 in order to provide communication between the client machine 12 and a server machine 16. Networks 14 are well known in the art and can include the internet, a wide area network, a local area network, or simply a connection between two computers. One skilled in the art will appreciate that other communication means between two computers are also known in the art. Further, in some situations where the server machine and the client machine are the same computer, network 14 may be a simulated internal communications channel.

Server machine 16 includes software for communicating with network 14, thereby allowing communications to and from client machine 12. Server machine 16 further includes software for communicating with a wireless data device 18 whose user interface is being simulated on client machine 12.

Wireless data device 18 and server machine 16 are connected through an interface 20. Interfaces between data devices and personal computers are well known, and can include, among others, a universal serial bus (USB) connection, an infrared connection, a Bluetooth connection, or other wired or wireless communication means.

Reference is now made to FIG. 2. The embodiment herein seeks to maintain the current display of wireless data device 18 on client machine 12. To do this, software on client machine 12 requests an update of the screen of the wireless data device 18 periodically. In a preferred embodiment, this screen update request 30 is performed every 500 milliseconds. However, depending on the requirements, the screen update request may be more or less frequent.

Screen update request 30 is sent by client machine 12 over network 14. Server machine 16 receives the screen update request 30 and in step 32 converts the request to an appropriate format for sending over interface 20.

Wireless device 18 receives the converted request over interface 20 and in step 34 interprets the request. Step 34 determines that an LCD display capture is being requested and wireless device 18 moves to step 36. In step 36, the LCD display is captured and wireless device 18 next moves to step 38.

In step 38, the captured LCD screen is compressed for transmission. One skilled in the art will realize that this compression step is optional and that data may be transmitted without being compressed.

Wireless device 18 next transmits the captured LCD screen over interface 20 back to server machine 16. Server machine 16 in step 40 converts the captured screen into a format acceptable for network transmission. Server machine 16 further sends the converted data from step 40 over network 14.

Client machine 12 receives the converted screen capture and in step 42 updates the display on its screen. In this way, the client machine 12 maintains a graphical display identical to the graphical display of the wireless data device 18.

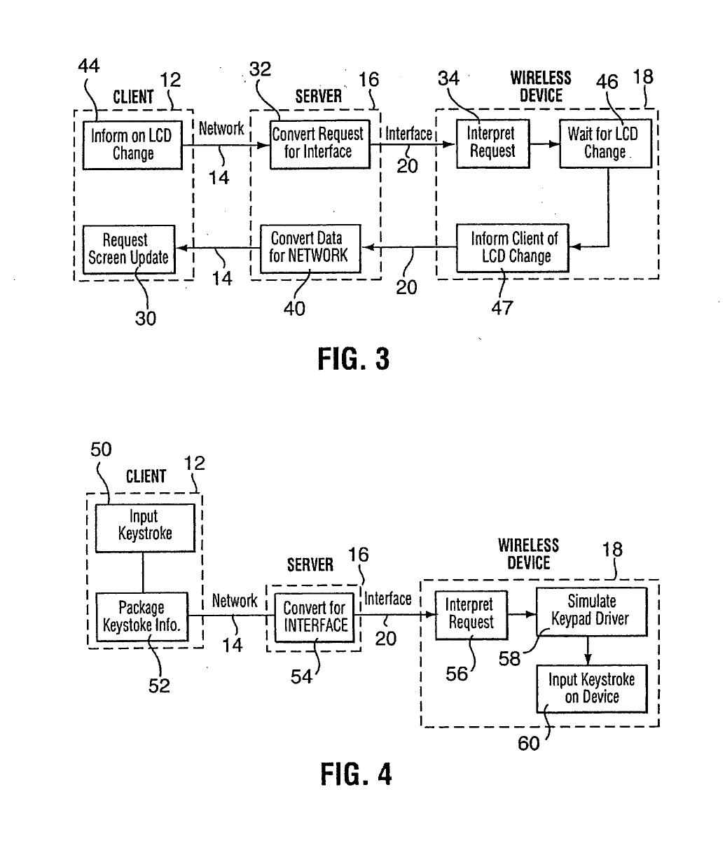

Reference is now made to FIG. 3. In one embodiment the constant requests for screen updates generate a significant amount of network traffic, which may be unacceptable to the network. In this case, a client 12 may request that the LCD display inform the client when the LCD display changes.

Changes in the LCD display may be a result of a user input, an automatic function such as a clock, received messages over the wireless network, or for other reasons known to those skilled in the art.

In FIG. 3, client machine 12 therefore requests in step 44 that wireless device 18 inform it when a change has occurred on the LCD display of wireless device 18. This request is sent over network 14 to server machine 16, where it is converted for interface 20 in step 32. This request is then sent over interface 20 to wireless device 18 where the request is interpreted at step 34. The wireless device then waits in step 46 for the LCD screen to change.

Once the LCD screen changes, wireless device 18 generates a message in step 47, which is sent over interface 20 to step 40, which converts the message for the network. The message is then sent over network 14 to step 30, in which the client machine requests a screen update. The request then follows the method described above in relation to FIG. 2.

In an alternative embodiment, in step 47 the wireless device could include a screen capture, and this could be sent over the network with screen compression step 38, or without it, depending on bandwidth availability. Client 12 in the alternative embodiment would perform an update screen step 42 rather than request a screen update.

Reference is now made to FIG. 4. In order to simulate keystrokes, a keystroke made on the client machine 12 is passed to wireless data device 18. A user inputs a keystroke in step 50 on client machine 12. The keystroke can be either input through a keyboard or if the graphics display includes a full representation of the wireless data device, including the keypad of the wireless data device, a mouse click on the appropriate key can also be registered. Other means for inputting data of the client machine 12 is known to those skilled in the art.

Client machine 12 in step 52 recognizes that a keystroke has been input and converts this keystroke into a packet that can be sent across network 14.

Server machine 16 receives the packet from step 52 and in step 54 converts this packet to be transferred across interface 20.

Wireless device 18 includes a driver handling the interface. This driver interprets the request in step 56. The interface driver recognizes that the data packet is a keystroke and in step 58 the interface driver simulates a keypad driver. In this way, the wireless data device 18 thinks that the input came from its keypad. The simulated keypad driver next uses the data packet created in step 54 to input a keystroke on the wireless data device 18 in step 60.

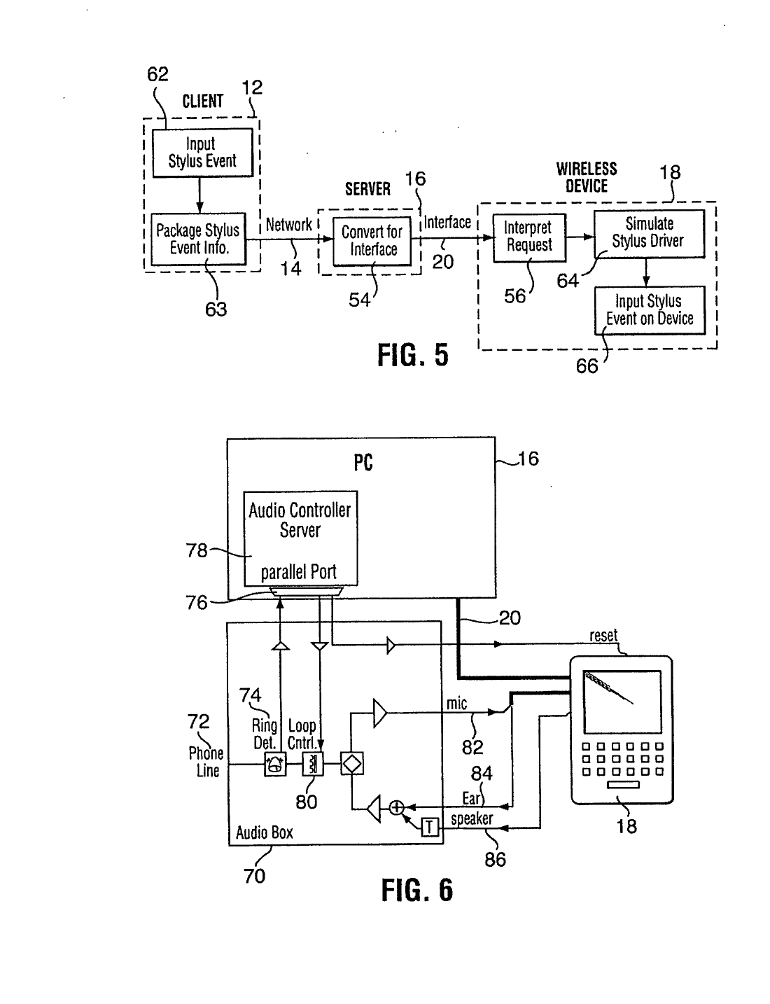

Reference is now made to FIG. 5. As an alternative to keypad inputs, a method to simulate a stylus event on the wireless device is provided. A stylus event could be simulated through the use of a mouse on client machine 12, where clicking the mouse could be a pen down simulation, releasing the mouse could be a pen up simulation, and dragging the mouse over the LCD representation on client machine 12 could simulate the dragging of the mouse on wireless device 18.

As one skilled in the art will realize, the dragging of the mouse over the LCD representation on client machine 12 will generate an X and Y coordinate for the stylus, and when this changes a new event is sent from client machine 12 to wireless device 18. The movement events may be only sent during mouse clicks to simulate a stylus with the pen down, or may be sent even when the mouse is not clicked in some applications.

Further, as one skilled in the art will realize, a client machine may use means other than a mouse to simulate a stylus, including a touch screen, a stylus on the client machine, or other devices know to those in the art.

In FIG. 5, a stylus event is registered on client machine 12 in step 62. This event, as indicated above, may be the clicking, releasing, or moving of the mouse on the LCD representation on client machine 12.

In step 63, the stylus event is packaged for network transmission and is transmitted over network 14. The server machine 16 converts the event information for interface 20 in step 54 and sends this information over interface 20.

In step 56 wireless device 18 interprets the request and finds it is a stylus event. Based on the request a stylus driver is simulated in step 64. The driver in step 64 is used to input the stylus event on wireless device in step 66.

In this way, the user can simulate a stylus event remotely, allowing the remote user to control the device in a manner similar to that which a local user could.

Based on the above, the combination of the steps in FIGS. 2 to 5 provide a client machine 12 with control of wireless data device 18 from a remote location. The display of the wireless data device is updated regularly on client machine 12 through either periodic update requests or based on changes in the display of wireless device 18. Keystrokes or stylus events can be input from client machine 12. The desired features are thereby accomplished.

Specifically, in debugging situations where a wireless network is only available at a remote location, the wireless device can be connected to a server machine at that remote location with all of the testing being accomplished from the client location. Also, in the case of technical support, the wireless data device can be connected to a computer running the appropriate software, and a technical support employee can then have full control over the wireless device.

For the training example, where the display of the wireless device is to be projected from a digital projector, client machine 12 and server machine 16 can be the same machine. In this case, network 14 is simulated on the client/server machine and communications between the client and server are performed on the same machine. Client machine 12 can further be connected to the digital projector. This allows wireless data device 18 to have its display projected through one computer running both client and server software.

Testing during the creation of a device is further provided for. In the case of a device in which a display or keypad have not yet been integrated into the hardware of the device, the present invention can be used to replace the display and keypad. Again, in this situation, client machine 12 and server machine 16 will be one machine and can be used in place of a display and keypad to ensure that the underlying hardware is working properly.

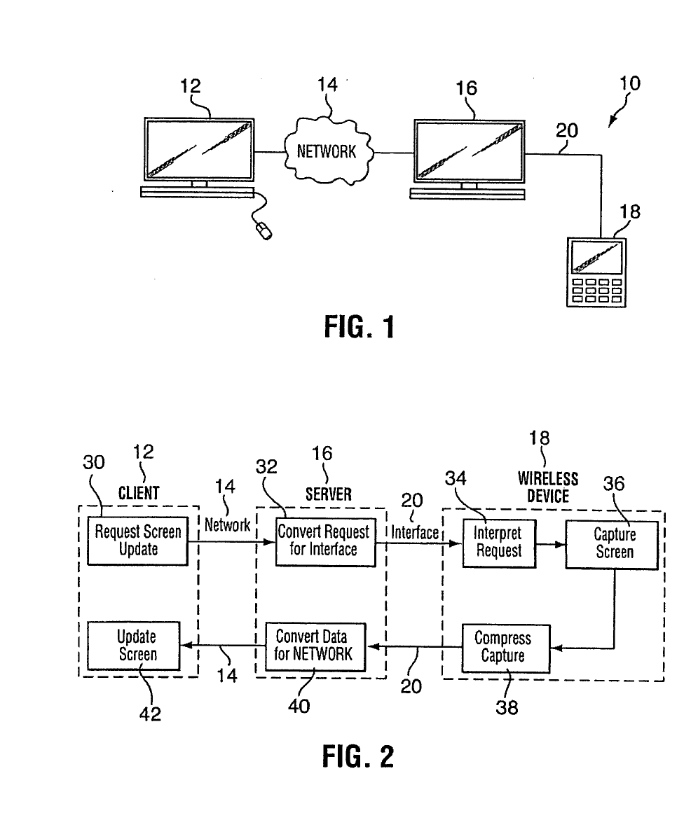

Reference is now made to FIG. 6. FIG. 6 shows an alternative embodiment in which capturing the audio functions of a wireless device is further required. As with the previous embodiments, a wireless data device 18 is connected to a server machine 16 using an interface 20. The screen display and keyboard inputs for the embodiment of FIG. 6 are the same as those of FIGS. 1-5.

An audio box 70 can be added in order to have the audio of wireless data device 18 available to a remote user. The remote user can dial to a telephone line connected to audio box 70. The client machine 12 can further send a pre-existing command to server machine 16 to answer the telephone call. Once the telephone call is answered by server machine 16, audio from wireless data device 18 is connected and the telephone of the user simulates the audio of the wireless data device.

As indicated in FIG. 6, phone line 72 is connected to audio box 70 and a ring detector 74 signals to server machine 16 through a parallel port 76 that the telephone is ringing. If server machine 16 has received a command from client machine 12 to answer, audio controller server 78 sends a signal to loop controller 80 to answer the telephone. Audio box 70 is further connected through a microphone input 82 and a headphone or speaker output 84 or 86 respectively.

Based on the above, an audio signal travelling along a phone line 72 is connected through microphone input 82 to wireless data device 18, and thus can simulate an audio input to the wireless device 18. Further, audio output from the wireless device is sent either through headphones 84 or speakers 86 and these are captured and sent back across phone line 72 to a user telephone.

As one skilled in the art will appreciate, rather than using a parallel port 76 for a custom built audio box, an audio PC board such as the Pica Inline™ or any modem with headset interface can be used.

There is therefore provided a complete simulation of the wireless data device, including possible audio interface to the wireless data device from a remote location. Some of the advantages of the remote connection are described above. Other advantages will be known to those skilled in the art.

The above-described embodiments are meant to be illustrative of preferred embodiments and are not intended to limit the scope of the present invention. Also, various modifications, which would be readily apparent to one skilled in the art, are intended to be within the scope of the present invention. The only limitations to the scope of the present invention are set forth in the following claims.

1. A remote user interface for a wireless data device comprising: a
client machine;
a server machine;
a communications channel for providing data exchange between said client machine and said server machine; and
an interface for providing data exchange between said server machine and said wireless data device,
wherein said client machine can send an input to said wireless data device using said communications channel and said interface, and said wireless device can provide information about a display on said wireless device to said client machine along said interface and said communications channel.

2. The remote user interface of claim 1, wherein said client machine is located remotely from said server machine.

3. The remote user interface of claim 1, wherein said interface is one of a USB connection, an infrared connection and a Bluetooth interface.

4. The remote user interface of claim 1, wherein said server machine converts data from said client machine based on said interface.

5. The remote user interface of claim 1 further comprising an audio box, said audio box having a telephone connection and being connected to a parallel port of said server machine and to a microphone input and a headset and speaker output of said wireless data device, wherein audio input and output to and from said wireless data device passes through said audio box and over said telephone line.

6. The remote user interface of claim 1, wherein said server machine further comprises an audio modem, said audio modem being connected to said wireless data device at a microphone input for said wireless data device and at a headset or speaker output of said wireless data device, said modem further being connected to the telephone line,
whereby audio input and output to and from said wireless data device is transferred over said telephone line.

7. The remote user interface of claim 1, wherein said input is a keystroke on said client machine.

8. The remote user interface of claim 6, wherein said keystroke is input from a keyboard.

9. The remote user interface of claim 6, wherein said keystroke is input by clicking a graphical representation of a keypad on said client machine.

10. The remote user interface of claim 1, wherein said input is a stylus event on said client machine.

11. The remote user interface of claim 9, wherein said stylus event is one of a mouse click, a mouse release, and a cursor drag over a graphical representation of a display of said wireless device on said client machine.

12. A method of updating a screen of a client machine to display a user interface of a wireless data device connected to a server machine, said method comprising the steps of:
generating a screen update request at said client machine;
transmitting said screen update request over a communication link between said client machine and said server machine;
converting screen update request to a data format appropriate for said wireless device;
transferring said converted request over an interface to said wireless data device;
interpreting said request at the said wireless data device;
capturing a screen of said wireless data device to create captured screen data;
transmitting said captured screen data to said server machine over said interface;
converting said captured screen data to a format appropriate for said client machine;
transmitting said converted captured screen data to said client machine; and updating the screen on said client machine.

13. The method of claim 12 further including the step of compressing said captured screen data between said step of capturing said screen and said step of transferring said captured screen to said server machine.

14. A method of remotely generating an input on a client machine for a wireless data device comprising the steps of:
receiving an input on said client machine;
sending said input to a server machine;
converting said input for an interface to said wireless data device; sending said input over said interface;
receiving said input at a wireless data device;
interpreting said input on said wireless data device;
simulating a driver for an input on said wireless data device; and inputting said input on said wireless data device.

15. The method of claim 14 wherein said input is one of a keystroke and a stylus event.

16. A method of updating a screen of a client machine to display unit user interface of a wireless data device connected to a server machine, said method comprising the steps of:
generating a request at said client machine to inform said client machine if said display on said wireless device changes;
transmitting said request over a communication link between said client machine and said server machine;
converting said request to a data format appropriate for said wireless device; transferring said converted request over an interface to said wireless data device;
interpreting said request at the said wireless data device;
waiting for said display at said wireless device to change;
transmitting a message to said server machine over said interface when said display changes;
converting said message to a format appropriate for said client machine; transmitting said converted message to said client machine; and
generating a screen update request at said client machine.

17. A method of updating a screen of a client machine to display unit user interface of a wireless data device connected to a server machine, said method comprising the steps of:
generating a request at said client machine to inform said client machine if said display on said wireless device changes;
transmitting said request over a communication link between said client machine and said server machine;
converting said request to a data format appropriate for said wireless device; transferring said converted request over an interface to said wireless data device;
interpreting said request at the said wireless data device;
waiting for said display at said wireless device to change;
capturing a screen of said wireless data device to create captured screen data one said display has changed;
transmitting said captured screen data to said server machine over said interface;
converting said captured screen data to a format appropriate for said client machine;
transmitting said converted captured screen data to said client machine; and updating the screen on said client machine.

18. A method of inputting and receiving audio signals from a remote location on a wireless device, said method comprising the steps of:
connecting an audio box to a telephone;
connecting said audio box to a headset and speaker output of said wireless device, said audio box being capable of relaying said headset and speaker output to said telephone;
connecting said audio box to a microphone input of said wireless device, said audio box being capable of relaying input from said telephone to said microphone input;
connecting said audio box to a parallel port of a client machine, said client machine being capable of sending commands to said audio box to answer said telephone;
sending a command to said client machine from a remote machine at said remote location to answer said telephone; and
telephoning said telephone from said remote location; and using said telephone to input and receive audio signals from said wireless device.
